(19) United States
(12) Patent Application Publication
(10) Pub. No.: US 2012/0202907 A1
(43) Pub. Date: Aug. 9, 2012

(54) LIGNIN BASED POLYOL FROM BLACK LIQUOR AND GLYCERINE

(76) Inventors: KURT KURPLE, East China, MI (US); NATHAN KURPLE, East China, MI (US)

(21) Appl. No.: 13/367,357

(22) Filed: Feb. 6, 2012

Related U.S. Application Data
(60) Provisional application No. 61/439,874, filed on Feb. 5, 2011.

(51) Int. Cl. C08G 18/32; C08G 63/00; C09K 3/00

(52) U.S. Cl. 521/170; 252/182.24; 528/85; 528/271

(57) ABSTRACT

A composition of waste glycerol and black liquor is disclosed. The composition is separated into two layers: the polyol layer and the aqueous layer. The polyol layer may be reacted with an isocyanate producing polyurethane foam, a polyurethane plastic or other polyurethane material. The glycerol contains one or more of the following compounds in various percentages: alcohols, such as ethanol or methanol, fatty acids, methyl esters, ethyl esters, triglycerides, diglycerides, monoglycerides, where said triglycerides, diglycerides and monoglycerides may be selected from the group of saturated, monounsaturated, and polyunsaturated.

This patent application claims priority to and the benefit of co-pending U.S. Provisional Patent Application Ser. No. 61,439,874 filed Feb. 5, 2011. U.S. Provisional Patent Application Ser. No. 61,439,874 filed Feb. 5, 2011 is incorporated by reference hereto in its entirety.

### BACKGROUND OF THE INVENTION

Over 10 billion pounds of polyurethanes are consumed annually. Polyurethanes are produced by reacting one or more isocyanates with one or more polyols. This reaction can be catalyzed by numerous additives including Surfactants, blowing Agents, and Cross-linking agents. Additional specialty additives can be used to adjust the characteristics of the polyurethane, such as fire retardance.

Since most polyols are based on petrochemical products, the cost of polyols is very dependent on the cost of oil. So, as the cost of oil increases, the cost of polyol, and therefore the cost of the polyurethane will also increase. These price increases limit the applications of polyurethane.

Recently, carbon neutral polyols have become popular. These polyols are based on vegetable oil feedstocks and ethylene oxides. The use of vegetable oils does reduce dependence on petroleum, however it is impacted by the price of food. And, while vegetable oil is harmless, ethylene oxide is a proven carcinogen. While vegetable oil-based polyols are technically carbon-neutral, they still require large amounts of fuel to produce, and are affected by the volatility of global food markets.

In addition to the market concerns of vegetable oil polyols, there is limited acceptance in the industry for several other reasons. First, they do not perform as well as petroleum based polyols. Second, they tend to pose several production problems. Third, they release ketones as they age, which, while harmless, do have a detectable odor.

### SUMMARY OF THE INVENTION

It has been shown that by using the lignin molecule, superior polyurethanes can be produced.

Lignin is a natural phenolic type molecule that occurs in wood, straw, sugar cane, and all other plants. The majority of the lignin that is produced as a byproduct of the paper pulping process and cellulosic ethanol industry is just burned to recover its heat value. In the United States alone over 50billion pounds of lignin are burned annually.

In spite of the advantages, the inventors believe that the inherent disadvantage of lignin, in the past, has been the separation from black liquor. This step significantly increases the cost of lignin. It also makes the lignin molecule less reactive. This is because dry lignin molecules become more spherical. The spherical shape reduces the number of active sites that are easily accessible to other reactive molecules.

It has been discovered that black liquor can be mixed with crude waste glycerol to form a lignin based polyol that reacts readily with isocyanate. This discovery enables the mass production of lignin-based polyols which in turn enables the mass production of polyurethanes using lignin-based polyols.

It has been found that a lignin-based polyol may be created from mixing black liquor and glycerol. This lignin-based polyol is useful in the production of polyurethanes that any conventional polyol might be used for, including: foams, coatings, adhesives, sealants, elastomers. The byproducts from the production of this material also have inherent value to numerous chemical industries.

The invention includes a composition, comprising: Glycerol, and black liquor, said mixture being separated into two layers: the lignin-based polyol layer and the aqueous layer.

### DESCRIPTION OF THE INVENTION

This polyol does not require epoxidation. Other work focuses on using the carbon skeletons of triglycerides or fatty acids to add OH groups in about one or two steps. It is preferable to use the carbon skeleton of lignin and the already active OH groups on the glycerol molecule.

This polyol is derived from over 90% waste materials that are domestically sourced, and are not price dependent on food or petroleum markets.

### EXAMPLE 1

To form a lignin-based polyol from black liquor and glycerol perform the following steps. In a suitable vessel, blend 500 parts of Black liquor from a Kraft process and 500 parts waste glycerol. A very dark solution will result. Now mix until a dark froth appears on the surface of the solution. As the sample settles, two distinct layers will form. The top layer will form a waxy lignin based polyol. The bottom layer will be aqueous and will contain most of the chemicals that are commonly recycled by paper mills. The two layers can be separated by centrifuging or similar methods.

### EXAMPLE 2

In order to produce a foam, 2 parts of the lignin based polyol of Example 1 is premixed with 0.05 parts water and 1 part Rubinate R1840 and then poured into a suitable container and a free rising foam will result.

### EXAMPLE 3

In order to produce a low density foam, a blowing agent can be mixed with this lignin based polyol in example 1. Two (2) parts of lignin based polyol of example 1 is premixed with 0.6 parts of Forane 141b (1.1 dichloro 1-fluroethane). Then this mixture is mixed with 1 part of Rubinate R-1840and then poured into a suitable container and a free rising foam with low density will result.

### EXAMPLE 4

In order to make a polyurethane coating based on the lignin based polyol of example 1, one part of the lignin based polyol of example 1 is mixed with 1 part of suitable coating solvent depending on the coating application. Then this premix is mixed with 1 part Rubinate R-1840 and the resulting mixture is used to coat a variety of substances. The viscosity of the resulting mixture can be adjusted with suitable solvents depending on the final coating application.

### EXAMPLE 5

To make a more rigid foam, 1.5 parts of the lignin based polyol of Example 1 is premixed with 0.5 part a Kraft lignin, 0.05 parts water and 1 part Rubinate R1840 and then poured into a suitable container and a free rising foam will result.

It is understood to those skilled in the art that Kraft black liquor or another type of black liquor can be employed. It is also understood that waster glycerol from a process other than biodiesel production could be employed

Method for Polyol Production

Equal masses of glycerol and black liquor were mixed in a five gallon bucket under a drum size JK disperser for one hour. The sample was allowed to settle overnight.

Two distinct layers can then be discerned with the naked eye. The top layer containing lignin-based polyol is dark brown, viscous, almost gelatinous. The bottom layer is aqueous and also dark brown. It is primarily water but may contain residual compounds, including: Sodium compounds, Potassium compounds, sugars, and tall oil. This top layer will be referred to as the lignin-polyol layer.

The glycerol used was waste crude glycerol from biodiesel production that uses both sodium hydroxide and potassium hydroxide as catalysts for biodiesel production. This glycerol is not pure, and may contain the following substances in various percentages: fatty acids, methyl ester, ethyl ester, triglycerides, diglycerides, monoglycerides, and other compounds that could result from either the large or small scale production of biodiesel.

The lignin-based polyol is a waxy solid at room temperature. The melting point is known to be between about 20 degrees Celsius and about 100 degrees Celsius.

Heat Catalyzation

Foams have been made using heat to catalyze the reaction instead of any chemical catalyst.

Polyol and isocyanate were mixed together in various ratios. The container was then placed over a flask containing boiling water. The steam passes along the outside of the container. The heat causes the causes the sample to foam. The transfer of heat from steam into the reaction mixture may be useful in any polyurethane system to replace expensive catalysts in the formulation.

Polyurethane was also made without catalyst simply by mixing at high speed with a Fawcett Co. Mixer with Jiffy Blade, and an IKA disperser.

The lignin based polyol layer properties

The lignin based polyol layer may be heated to around 100 degrees Celsius to boil off excess water. It is well known that water may be used in polyurethanes to act as a blowing agent. If there is too much water in the lignin-based polyol layer, the foam will be blown out too much, and collapse, with very low final volume. It is desirable to remove water almost completely from the polyol. Then, add water in each formulation in various quantities to find the optimum balance between the lignin-based polyol, water, blowing agents, cross-linkers, catalysts, and isocyanate.

This was done in producing the lignin-based polyol that was used to make polyurethane samples.

The lignin-based polyol is solid at room temperature. The melting point is known to be between about 20 degrees Celsius and about 100 degrees Celsius, This polyol can be produced from feedstocks that are close to 100% renewable and domestic.

Waste Water

The Aqueous Layer likely contain numerous compounds of value to the chemical industry, including sugar, tall oil, Sodium compounds, Potassium compounds, and Sulfur compounds.

Vertical Integration

A facility that produces Polyol from two waste streams will find it advantageous to integrate the production of the streams into one business. One iteration of this would be for one company to own a biodiesel plant, a polyol plant, and a pulp and paper plant. The biodiesel plant produces glycerol and biodiesel, and consumes sodium hydroxides and vegetable oil. The glycerol would be used to produce polyol.

The biodiesel would be used to ran the polyol plant and the paper plant or be sold, depending on market conditions. The polyol plant would produce polyol to sell, and Sodium compounds to be used in the paper mill and biodiesel plant. It would also produce sugars and tall oil to be used in the biodiesel plant.

The paper mill, would use Sodium from the polyol plant, and return black liquor, while selling paper products.

The integration of these three businesses could provide reduction in costs associated with transportation, licensing, and disposal costs. Integration can also be carried down to the polyol user.

What is claimed is:

1. A composition, comprising: waste glycerol and black liquor, said composition forming two layers, a polyol layer and an aqueous layer.

2. A composition as claimed in claim 1 wherein said polyol layer is reacted with an isocyanate producing polyurethane foam, a polyurethane plastic or other polyurethane material.

3. A composition as claimed in claim 1 wherein said waste glycerol contains one or more of the following compounds: alcohols, such as ethanol, methanol, isopropanol, and propanol; fatty acids; methyl esters; ethyl esters; triglycerides, diglycerides, and monoglycerides, wherein said triglycerides, diglycerides and monoglycerides may be selected from the group of saturated, monounsaturated, and polyunsaturated fat.

4. A composition as claimed in claim 2 wherein said waste glycerol is derived from biodiesel production.

5. A composition as claimed in claim 1 wherein said waste glycerol includes a soap, said soap selected from the group of: sodium soap, such as sodium stearate; potassium soap, such as potassium laureate; myristate; oleate; linoleate; linolenate and plamiteate.

6. A composition as claimed in claim 1 where black liquor is derived from a solvent pulping process.

7. A composition as claimed in claim 1 wherein said black liquor is derived from the Kraft paper pulping process.

8. A composition as claimed in claim 1 wherein said black liquor is derived from a biomass process.

9. A composition as claimed in claim 1 wherein said black liquor is derived from a mechanical pulping process.

10. A composition as claimed in claim 1 wherein said black liquor is derived from a sulfite paper pulping process.

11. A composition as claimed in claim 1 wherein said black liquor is derived from a semi-mechanical pulp.

12. A composition as claimed in claim 1 wherein additional lignin powder that is derived from a biomass process, Kraft paper pulping process, mechanical pulping process, sulfite paper pulping process, or semi-mechanical pulping process is added to the product polyol.

13. A composition as claimed in claim 1 wherein said polyol layer has lower viscosity than conventional lignin polyols.

14. A composition as claimed in claim 1 wherein said polyol layer has lower acid number than conventional lignin polyols.

15. A composition as claimed in claim 1 wherein said top layer is reacted with an acrylic acid and being used to form a thermoplastic.

16. A composition as claimed in claim 1 wherein said top layer is reacted with melamine to form a coating.

17. A composition as claimed in claim 1 wherein said black liquor is replaced with a mixture containing water, lignin, and sodium hydroxide.

18. A composition, comprising: waste glycerol and a mixture; said mixture containing water, lignin, sodium hydroxide, sodium sulfide, sugars, and tall oil; said composition being separated into two layers: and, the polyol layer and the aqueous layer.

19. A composition as claimed in claim 17 wherein said sodium hydroxide is replaced with another hydroxide, such as calcium or potassium hydroxide.

20. A composition as claimed in claim 1 wherein said polyol is reacted with one or more lignins.
